(19) United States
(12) Patent Application Publication
(10) Pub. No.: US 2016/0037969 A1
(43) Pub. Date: Feb. 11, 2016

(54) Flare-up Preventing Grill

(71) Applicant: John Robin Renner, Haysville, KS (US)

(72) Inventor: John Robin Renner, Haysville, KS (US)

(21) Appl. No.: 14/819,268

(22) Filed: Aug. 5, 2015

Related U.S. Application Data
(60) Provisional application No. 62/033,323, filed on Aug. 5, 2014.

(51) Int. Cl. A47J 37/07

(52) U.S. Cl. CPC A47J 37/0786; A47J 37/07

(57) ABSTRACT

A flare-up preventing grill is an apparatus which is useful for preventing and extinguishing flare-ups which occur while grilling. The flare-up preventing grill includes a grill lid and a grill body in which food may be grilled upon a cooking grate. The flare-up preventing grill includes a heat source used for cooking foods and for boiling water contained within a water storage system. Water from the water storage system produces steam and a mist of water droplets when boiled. The flare-up preventing grill includes a baffle system which is permits or restricts the flow of the water droplets within a grill receptacle of the grill body. The grill body includes a steam regulating outlet which controls the amount of water droplets within the grill receptacle. The grill body includes a steam overflow outlet which permits water droplets to exit the grill receptacle when the baffle system is closed.

The current application claims a priority to the U.S. Provisional Patent application Ser. No. 62/033,323 filed on Aug. 5, 2014.

### FIELD OF THE INVENTION

The present invention generally relates to the field of outdoor grilling with propane or natural gas. Specifically, the present invention is a grill which prevents and suppresses grease fires which commonly flare up when cooking fatty foods. This is done by creating steam and water droplets inside the sealed cooking chamber of the grill via boiling water and creating only one pathway that the steam and water droplets can escape.

### BACKGROUND OF THE INVENTION

Grilling is a common method of cooking foods that requires constant monitoring.

Because food is in the presence of an open flame, the cook must maintain a watchful eye so as to make sure that the food does not burn. When foods are cooked on a grill, they tend to release juices that were previously trapped inside the food. Grease is a liquid that is often released from foods like steak, hamburgers, and sausages and contains animal fat which is flammable. As grease drips from the food, it may fall on a hot baffle or come in contact with a flame. When this happens, it is common for the grease to ignite, producing a flame that can reach the foods inside the grill. While producing large flames may be desirable under some circumstances, it is often a situation that cooks avoid because larger flames can burn the food inside of the grill and can be dangerous.

The most common approach to dealing with grease fires is to spray or pour water directly onto the fire. This approach is relatively effective at extinguishing flare-ups, but does not prevent flare-ups in any way. Currently, there is no solution to actively prevent and extinguish flare-ups. The present invention solves the problem of grease fires by regulating the level of water droplets and steam generated from boiling water inside the closed system of the grill. The grill contains a water reservoir filled with water that, when heated by a heat source, begins to boil. The amount of steam and water droplets within the grill may be controlled by a steam regulating outlet. A baffle system is used to further protect against flare-ups when the grill lid is open by preventing steam and water droplets from exiting the grill.

### SUMMARY OF THE INVENTION

The present invention relates to an outdoor grill which includes a water reservoir that can be heated by a natural gas or propane heat source to the point that boiling water fills the sealed cooking chamber of the grill with steam and water droplets. The grill has been designed to allow water droplets and steam from the boiling of water, along with the combustion products of cooking, to escape from the grill through only one exit when the lid is closed. When the heat source is lit, the flames heat water which is stored inside a reservoir. As the water begins to boil, water droplets and steam escape through vents in the reservoir and stay suspended inside the grill. The presence of these water droplets suppress flare-ups and help maintain a constant cooking temperature inside the grill. During cooking, the grill is sealed so that the water droplets and steam can only escape through specially designed venting. Because the water droplets are trapped inside the body of the grill, the water droplets become heated by the flames of a flare-up which is caused by grease dripping from foods. The heat from these flare-ups causes the water droplets to change phase and turn into steam. For water to undergo a liquid-to-gas phase change, it must absorb a large amount of energy. In this case, the energy of the flare-up is absorbed by the water droplets, turning the water droplets to steam, thereby cooling and extinguishing the flame. The level of the water droplets and steam inside the cooking chamber is regulated by two vents on the back face of the present invention. The upper vent drives the water droplets and steam down to or slightly past the level of lava rocks, ceramic bricks, or any surface where flare-ups occur before allowing the steam, water droplets and smoke from cooking to escape into the atmosphere. The lower vent allows water droplets and steam to escape when the baffle system is closed and additionally, allows proper, unimpeded, ventilation of the heat source for clean and efficient combustion.

### BRIEF DESCRIPTION OF THE DRAWINGS

FIG. 1 is a front perspective view of the present invention with the lid in a closed.

FIG. 2 is a front perspective view of the present invention with the lid in an open position.

FIG. 3 is a rear perspective view of the present invention.

FIG. 4 is a rear perspective view of the present invention showing an alternative design for the steam regulating outlet.

FIG. 5 is a top view of the present invention.

FIG. 6 is a front cross-sectional view of the present invention taken about the line A-A in FIG. 5.

FIG. 7 is a detailed view of the present invention taken from circle B in FIG. 5.

FIG. 8 is a front view of the water storage system of the present invention.

FIG. 9 is a front view of an alternative embodiment of the water storage system.

FIG. 10 is a front view of the present invention.

FIG. 11 is a right cross-sectional view of the present invention taken about the line C-C in FIG. 10.

FIG. 12 is a detailed view of the present invention taken from circle D in FIG. 11.

### DETAILED DESCRIPTION OF THE INVENTION

All illustrations of the drawings are for the purpose of describing selected versions of the present invention and are not intended to limit the scope of the present invention.

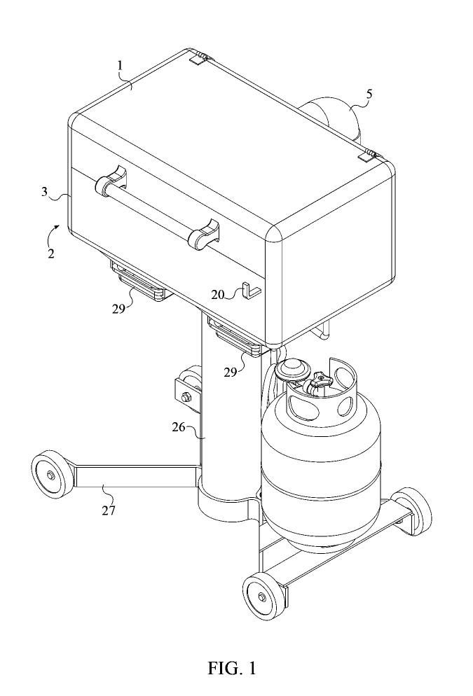

With reference to FIGS. 1-3, the present invention is a flare-up preventing grill that is capable of preventing grease from igniting while grilling and minimizing the effects of flare-ups. This is done by using heat to boil water which creates water droplets and steam that fills the inside of the grill. The present invention comprises a grill lid 1, a grill body 2, a water storage system 7, a cooking grate 17, a baffle system 18, and a heat source 21. The grill body 2 makes up the majority of the grill and comprises a grill receptacle 3, a steam regulating outlet 5, and a steam overflow outlet 6. The grill lid 1 is perimetrically attached onto an opening 4 of the grill receptacle 3. The grill lid 1 may be attached onto the grill receptacle 3 in a number of ways, including a hinge, a sliding engagement, or, more simply, the grill lid 1 may fit over the grill receptacle 3. The grill receptacle 3 houses most of the components of the grill. When the grill lid 1 is in a closed position, the grill lid 1 and the grill receptacle 3 form a chamber that fills with water droplet and steam from boiling water contained within the water storage system 7 along with smoke and combustion products from cooking. The water droplets, steam and smoke are primarily allowed to escape only through one exit, the steam regulating outlet 5. The trapped water droplets in the grill receptacle 3 undergo a liquid to gas phase change when they come into contact with flames from a grease induced flare up by absorbing so much of the flames energy that the flame is cooled and extinguished. This helps to prevent flare-ups. Closing the grill lid 1 is also useful for increasing the cooking temperature inside the grill receptacle 3. The cooking grate 17 is mounted within the grill receptacle 3, adjacent to an opening 4 of the grill receptacle 3. The cooking grate 17 is used to support food items above the heat source 21 while grilling.

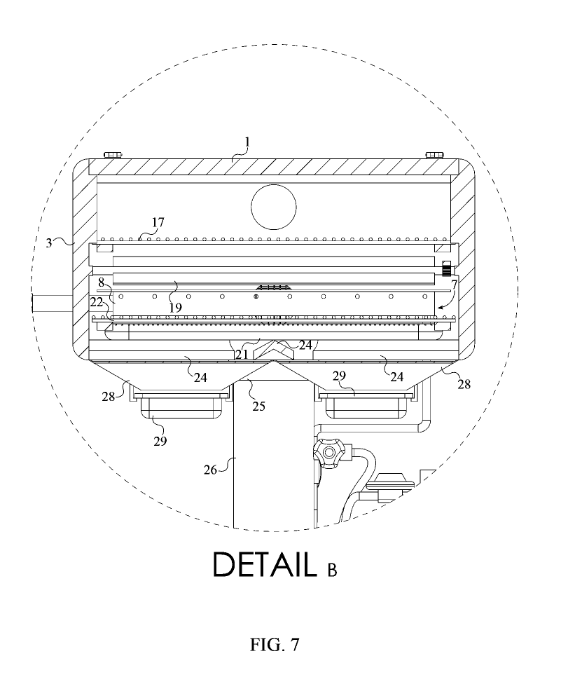

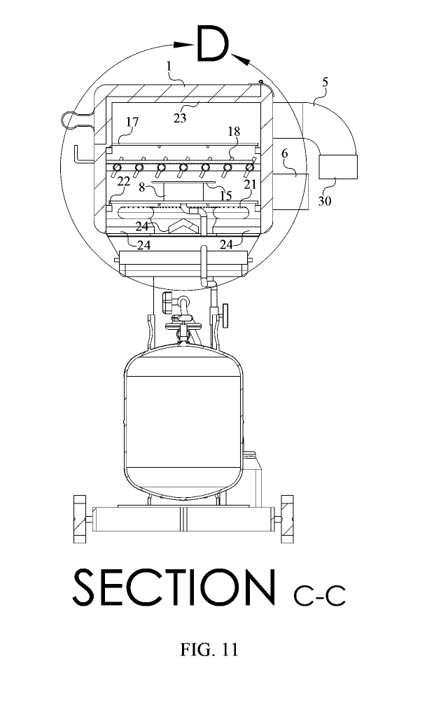

The baffle system 18, as seen in FIG. 7 and FIG. 11, is mounted within the grill receptacle 3, adjacent to the cooking grate 17 and opposite to the grill lid 1. The baffle system 18 is used permit or restrict the ability of water droplets to fill the grill receptacle 3. The water storage system 7 is mounted within the grill receptacle 3, adjacent to the baffle system 18 and opposite to the cooking grate 17. Water is kept in the water storage system 7 and is released as steam when heated by the heat source 21. This steam quickly condenses into a fine mist of water droplets which helps to prevent flare-ups. The baffle system 18 is also useful in keeping a water-rich environment inside the grill receptacle 3 when the grill lid 1 is opened. Before opening the grill lid 1, the user may close the baffle system 18. This will trap water droplets between the baffle system 18, and the heat source 21 thereby preventing flare-ups within that region of the grill receptacle 3. Otherwise, opening the grill lid 1 would allow water droplets to escape, thus creating an environment which is more prone to flare-ups. The steam overflow outlet 6 allows steam and water droplets to escape the grill when the lid 1 is open and the baffle 18 is closed so that the combustion of the heat source 21 is not compromised or cooled by the water droplets or steam.

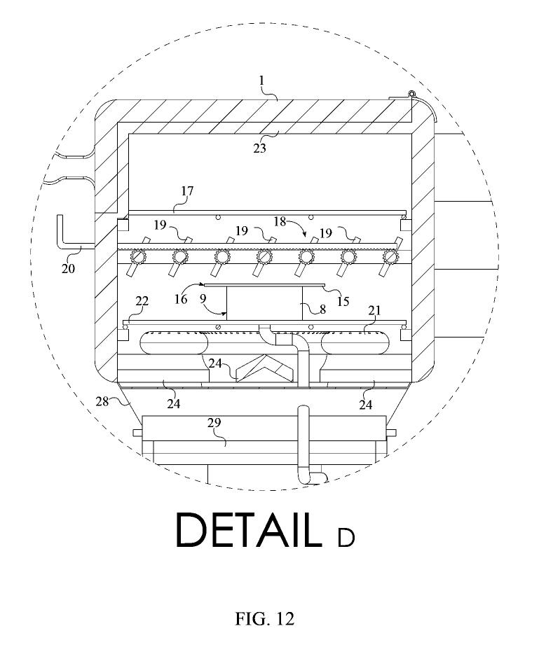

In reference to FIG. 12, the heat source 21 is mounted within the grill receptacle 3, adjacent to the water storage system 7 and opposite to the baffle system 18. The heat source 21 is used to cook food and to boil water in the water storage system 7. The preferred embodiment of the present invention uses a propane burner as the heat source 21. Accordingly, various other standard components are required to operate a propane burner. Such components include, but are not limited to, a Venturi tube, a control valve, a pressure regulator, and a propane tank. Conversely, the heat source 21 may also take the form of a natural gas burner, charcoal, or any other suitable means. To prevent flare-ups, heat from the heat source 21 warms water in the water storage system 7, the water boils and water droplets are expelled from the water storage system 7. The baffle system 18 may opened or closed to either permit the water droplets to fill the grill receptacle 3 or prevent the water droplets from filling the grill receptacle 3.

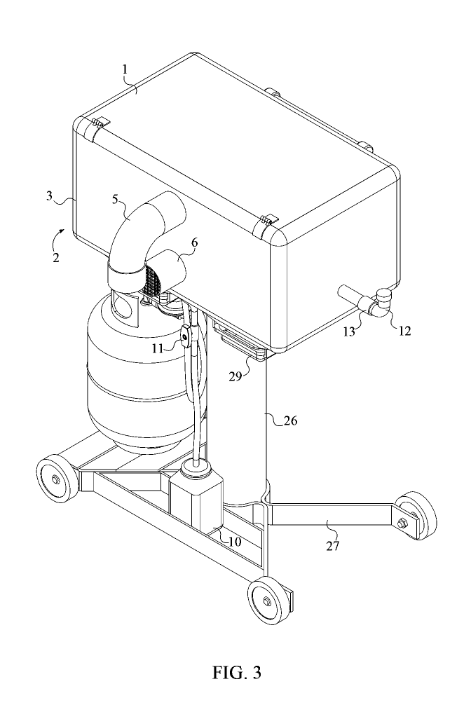

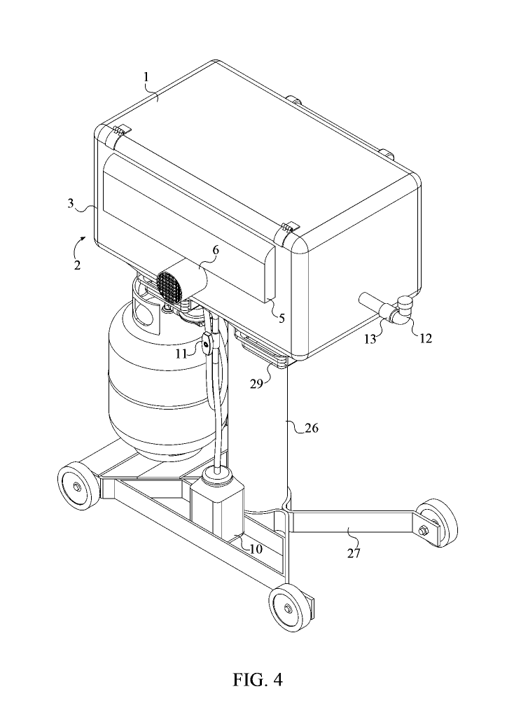

In reference to FIGS. 3-4 and FIG. 11, the steam regulating outlet 5 traverses out of the grill receptacle 3, adjacent to the grill lid 1. As the amount of water droplets within the grill receptacle 3 increases, the steam regulating outlet 5 permits some of the water droplets to escape the grill receptacle 3 such that an optimal amount of water droplets is kept within the grill receptacle 3. In reference to FIG. 3, the steam regulating outlet 5 may resemble a pipe which extends from the grill receptacle 3. Alternatively, as shown in FIG. 4, the steam regulating outlet 5 may resemble a vent which runs along a panel of the grill receptacle 3. The grill receptacle 3 is in fluid communication into a flow adjustment valve 30 through the steam regulating outlet 5. The flow adjustment valve 30 acts as a means of fine tuning the level of water droplets and steam inside the grill receptacle 3. In the preferred embodiment of the present invention, the flow adjustment valve 30 is in the form of a collar that is slidably engaged about the steam regulating outlet 5. One other possible embodiment of the flow adjustment valve 30 could include a panel which may be used to obstruct all or part of the steam regulating outlet 5. Further additional embodiments of the flow adjustment valve 30 may alternatively be used.

The steam overflow outlet 6 traverses out of the grill receptacle 3, adjacent to the grill lid 1. The steam overflow outlet 6 traverses out of the grill receptacle 3, adjacent to the cooking grate 17 and opposite to the steam regulating outlet 5. The steam overflow outlet 6 is a secondary means of disposing of excess amounts of water droplets. In the event that water is boiling too rapidly, the steam overflow outlet 6 is used to release excessive amounts of water droplets to prevent the fire of the heat source 21 from burning inefficiently or extinguishing due to a presence of excess water. The steam overflow outlet 6 is used for the same purpose if the user is grilling with the baffle system 18 in a closed position.

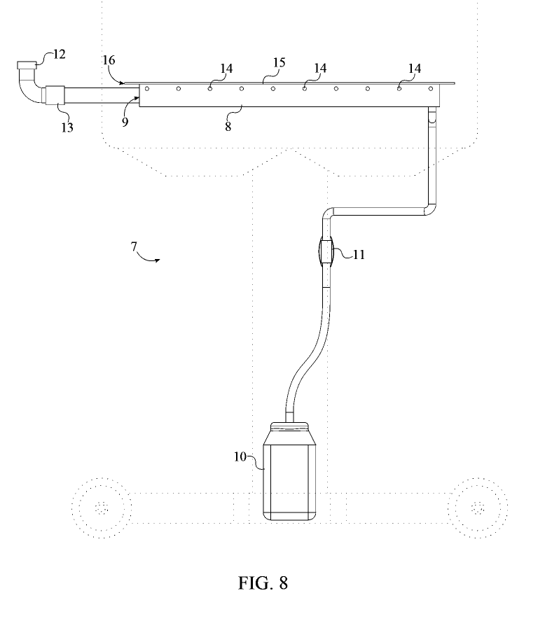

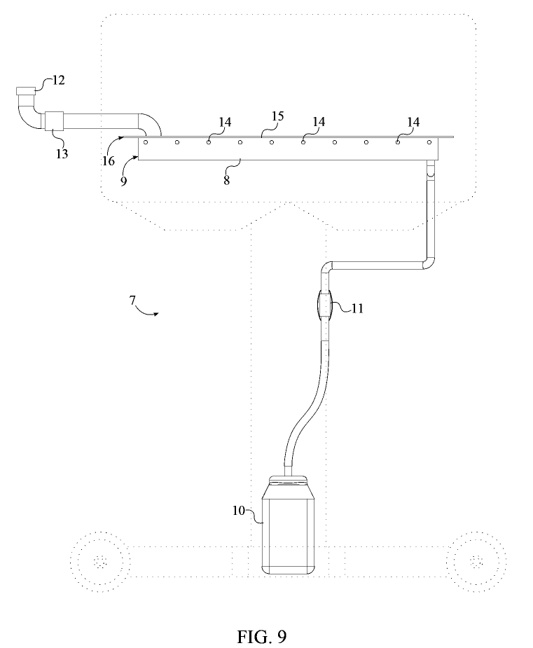

In reference to FIGS. 8-9 and FIG. 12, the water storage system 7 comprises a water reservoir 8, a waste bottle 10, a drainage valve 11, an inlet pipe 12, and a one-way valve 13. The inlet pipe 12 is used to add water to the water reservoir 8. The inlet pipe 12 traverses through the grill receptacle 3 and is in fluid communication into the water reservoir 8 through the one-way valve 13. In one embodiment of the water storage system 7, the inlet pipe 12 is in fluid communication with the water reservoir 8 through the side of the water reservoir 8. This is shown in FIG. 8. In an alternative embodiment of the water storage system 7, shown in FIG. 9, the inlet pipe 12 is in fluid communication with the water reservoir 8 through the top of the water reservoir 8. The one-way valve 13 allows water to enter the water reservoir 8 from the inlet pipe 12, but prevents water droplets from traveling in the opposite direction. This prevents steam or hot water from being released through the inlet pipe 12 and potentially harming the user. The waste bottle 10 is positioned outside the grill receptacle 3 and is used for disposing of unwanted water from the water reservoir 8. The water reservoir 8 is in fluid communication with the waste bottle 10 through the drainage valve 11. The drainage valve 11 is used to control whether water stored in the water reservoir 8 or drained into the waste bottle 10.

Periodically, the user may empty water from the water reservoir 8 to ensure that water within the water reservoir 8 is clean.

The water storage system 7 further comprises a plurality of vents 14 and a deflector shield 15. The plurality of vents 14 traverses through the water reservoir 8, opposite to the heat source 21. The plurality of vents 14 is used to allow steam and fine droplets of water to escape the water reservoir 8 when the water is heated. The deflector shield 15 is mounted to the water reservoir 8, adjacent to the plurality of vents 14. A lateral edge 16 of the deflector shield 15 is positioned offset from a lateral surface 9 of the water reservoir 8. In this arrangement, the deflector shield 15 is positioned in-between the cooking grate 17 and the plurality of vents 14. When grease drips from food, and onto the deflector shield 15, the offset between the lateral edge 16 of the deflector shield 15 and the lateral surface 9 of the water reservoir 8 guides grease away from the plurality of vents 14 and prevents the grease from dripping into the water reservoir 8.

In reference to FIG. 12, the present invention further comprises a support grate 22. The support grate 22 is used to hold the water reservoir 8 in position within the grill receptacle 3. The support grate 22 is laterally mounted within the grill receptacle 3 and is positioned in-between the water reservoir 8 and the heat source 21. The water storage system 7 is mounted within the grill receptacle 3 by the support grate 22 because the open structure of the support grate 22 allow heat to easily travel from the heat source 21 to the water reservoir 8. Moreover, lava rocks or ceramic briquettes may also be placed on the support grate 22 to better capture grease.

In reference to FIGS. 11-12, the baffle system 18 comprises a plurality of louvers 19 and a rotation actuator 20. Each of the plurality of louvers 19 is rotatably mounted within the grill receptacle 3. The plurality of louvers 19 may be opened or closed to permit or restrict the spread of water droplets throughout the grill receptacle 3. The position of the plurality of louvers 19 is controlled by the rotation actuator 20 which is mechanically coupled to each of the plurality of louvers 19. In the preferred embodiment of the present invention, each of the plurality of louvers 19 are integrated with a pinion which engages with a rack gear of the rotation actuator 20. The rotation actuator 20 adjusts the angle of each of the plurality of louvers 19 when the rotation actuator 20 is moved towards or away from the grill receptacle 3.

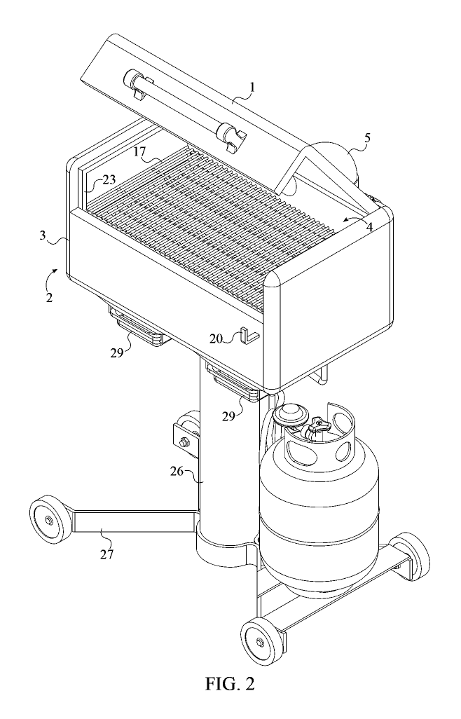

In reference to FIG. 2, the present invention further comprises a lip 23 which is used to aid in preventing water droplets from escaping the grill receptacle 3. The lip 23 is internally connected to the grill receptacle 3 about the opening 4 of the grill receptacle 3. The grill lid 1 is perimetrically aligned with the lip 23 such that a seal is created when the grill lid 1 is closed. As a result, the only way for water droplets to leave the grill receptacle 3 is through the steam regulating outlet 5 or the steam overflow outlet 6.

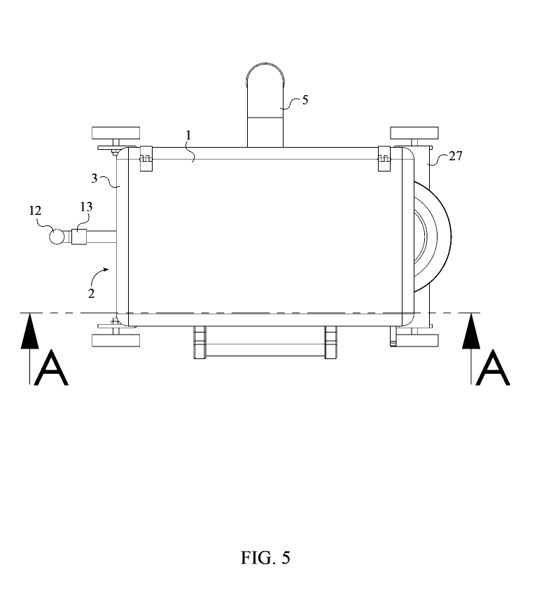

In reference to FIGS. 5-7, the present invention further comprises a plurality of support arms 24, a collar 25, a shaft 26, and a base 27. The plurality of support arms 24 is radially positioned around the collar 25. The collar 25 is internally mounted to the grill receptacle 3 by the plurality of support arms 24. Together the plurality of support arms 24 and the collar 25 are used to attach the grill body 2 to the shaft 26. In the preferred embodiment of the present invention, the cross-section of each of the plurality of support arms 24 is triangular in shape, with a corner of the triangular cross-section oriented towards the grill opening 4. This configuration is useful because a triangular cross-section helps to deflect grease that drips onto the plurality of support arms 24, thus preventing a buildup of grease. The collar 25 and the base 27 are laterally mounted about the shaft 26. The collar 25 and the base 27 are offset from each other along the shaft 26. The base 27 is used to provide a stable foundation to support the rest of the grill. In the preferred embodiment, the base 27 is equipped with a plurality of wheels, increasing the portability of the present invention. It is also preferred that the waste bottle 10 is mounted to the base 27.

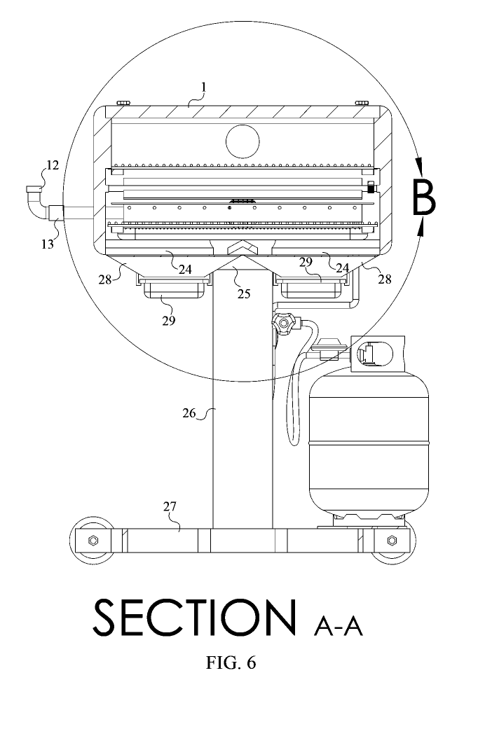

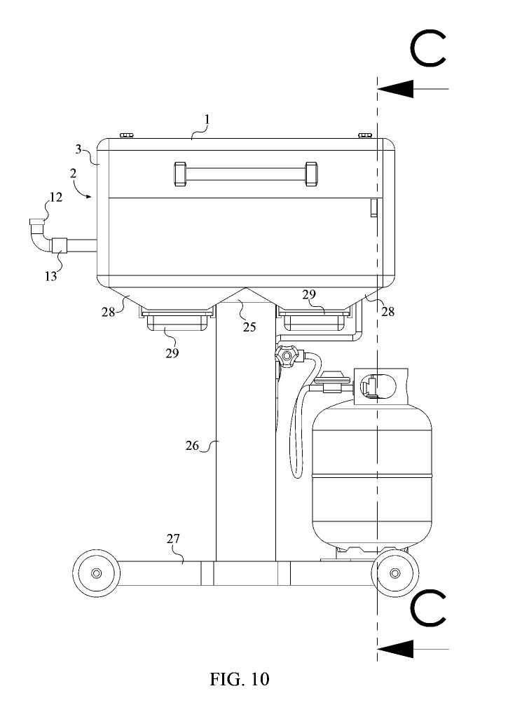

In reference to FIG. 6 and FIG. 10, the present invention further comprises at least one grease funnel 28 and at least one grease pan 29. The at least one grease funnel 28 is integrated into the grill receptacle 3, opposite to the grill lid 1. The at least one grease funnel 28 is used to concentrate where grease drips such that grease may be collected and disposed of easily. The at least one grease funnel 28 is in fluid communication into the at least one grease pan 29. The at least one grease pan 29 is externally mounted to the grill receptacle 3 and is used to collect grease that drips from the at least one grease funnel 28. In the preferred embodiment of the present invention, the at least one grease pan 29 is supported just below the at least one grease funnel 28 by one or more brackets. In the preferred embodiment of the present invention, there are two grease funnels 28 which are positioned opposite to each other about the shaft 26. In this embodiment, a grease pan 29 is positioned under each of the grease funnels 28 to collect grease as it drips.

Although the invention has been explained in relation to its preferred embodiment, it is to be understood that many other possible modifications and variations can be made without departing from the spirit and scope of the invention as hereinafter claimed.

What is claimed is:

1. A flare-up preventing grill comprises:
a grill lid;
a grill body;
a water storage system;
a cooking grate;
a baffle system;
a heat source;
the grill body comprises a grill receptacle, a steam regulating outlet, and a steam overflow outlet;
the grill lid being perimetrically attached onto an opening of the grill receptacle;
the cooking grate being mounted within the grill receptacle, adjacent to the opening of the grill receptacle;
the baffle system being mounted within the grill receptacle, adjacent to the cooking grate and opposite to the grill lid;
the water storage system being mounted within the grill receptacle, adjacent to the baffle system and opposite to the cooking grate;
the heat source being mounted within the grill receptacle, adjacent to the water storage system and opposite to the baffle system;
the steam regulating outlet traversing out of the grill receptacle, adjacent to the grill lid; and
the steam overflow outlet traversing out of the grill receptacle, adjacent to the cooking grate and opposite to the steam regulating outlet.

2. The flare-up preventing grill as claimed in claim 1 comprises the grill receptacle being in fluid communication with a flow adjustment valve through the steam regulating outlet.

3. The flare-up preventing grill as claimed in claim 1 comprises:
the water storage system comprises a water reservoir, a waste bottle, a drainage valve, an inlet pipe, and a one-way valve;
the inlet pipe traversing through the grill receptacle;
the inlet pipe being in fluid communication into the water reservoir through the one-way valve;
the waste bottle being positioned outside the grill receptacle; and
the water reservoir being in fluid communication with the waste bottle through the drainage valve.

4. The flare-up preventing grill as claimed in claim 3 comprises:
the water storage system further comprises a plurality of vents and a deflector shield;
the plurality of vents traversing through the water reservoir, opposite to the heat source;
the deflector shield being mounted to the water reservoir, adjacent to the plurality of vents; and
a lateral edge of the deflector shield being positioned offset from a lateral surface of the water reservoir.

5. The flare-up preventing grill as claimed in claim 3 comprises:
a support grate;
the support grate being laterally mounted within the grill enclosure;
the support grate being positioned in-between the water reservoir and the heat source; and
the water storage system being mounted within the grill receptacle by the support grate.

6. The flare-up preventing grill as claimed in claim 1 comprises:
the baffle system comprises a plurality of louvers and a rotation actuator;
each of the plurality of louvers being rotatably mounted within the grill receptacle; and
the rotation actuator being mechanically coupled to each of the plurality of louvers.

7. The flare-up preventing grill as claimed in claim 1 comprises:
a lip;
the lip being internally connected to the grill receptacle about the opening of the grill receptacle; and
the grill lid being perimetrically aligned with the lip.

8. The flare-up preventing grill as claimed in claim 1 comprises:
a plurality of support arms;
a collar;
a shaft;
a base;
the plurality of support arms being radially positioned around the collar;
the collar being internally mounted to the grill receptacle by the plurality of support arms;
the collar being laterally mounted about the shaft;
the base being laterally mounted about the shaft; and
the collar and the base being offset from each other along the shaft.

9. The flare-up preventing grill as claimed in claim 1 comprises:
at least one grease funnel;
at least one grease pan;
the at least one grease funnel being integrated into the grill receptacle, opposite to the grill lid;
the at least one grease funnel being in fluid communication into the at least one grease pan; and
the at least one grease pan being externally mounted to the grill receptacle.

10. A flare-up preventing grill comprises:
a grill lid;
a grill body;
a water storage system;
a cooking grate;
a baffle system;
a heat source;
the grill body comprises a grill receptacle, a steam regulating outlet, and a steam overflow outlet;
the water storage system comprises a water reservoir, a waste bottle, a drainage valve, an inlet pipe, and a one-way valve;
the grill lid being perimetrically attached onto an opening of the grill receptacle;
the cooking grate being mounted within the grill receptacle, adjacent to the opening of the grill receptacle;
the baffle system being mounted within the grill receptacle, adjacent to the cooking grate and opposite to the grill lid;
the water storage system being mounted within the grill receptacle, adjacent to the baffle system and opposite to the cooking grate;
the heat source being mounted within the grill receptacle, adjacent to the water storage system and opposite to the baffle system;
the steam regulating outlet traversing out of the grill receptacle, adjacent to the grill lid;
the steam overflow outlet traversing out of the grill receptacle, adjacent to the cooking grate and opposite to the steam regulating outlet;
the inlet pipe traversing through the grill receptacle;
the inlet pipe being in fluid communication into the water reservoir through the one-way valve;
the waste bottle being positioned outside the grill receptacle; and
the water reservoir being in fluid communication with the waste bottle through the drainage valve.

11. The flare-up preventing grill as claimed in claim 10 comprises the grill receptacle being in fluid communication with a flow adjustment valve through the steam regulating outlet.

12. The flare-up preventing grill as claimed in claim 10 comprises:
the water storage system further comprises a plurality of vents and a deflector shield;
the plurality of vents traversing through the water reservoir, opposite to the heat source;
the deflector shield being mounted to the water reservoir, adjacent to the plurality of vents; and
a lateral edge of the deflector shield being positioned offset from a lateral surface of the water reservoir.

13. The flare-up preventing grill as claimed in claim 10 comprises:
a support grate;
a plurality of support arms;
a collar;
a shaft;
a base;
the support grate being laterally mounted within the grill enclosure;
the support grate being positioned in-between the water reservoir and the heat source;
the water storage system being mounted within the grill receptacle by the support grate;
the plurality of support arms being radially positioned around the collar;
the collar being internally mounted to the grill receptacle by the plurality of support arms;
the collar being laterally mounted about the shaft;
the base being laterally mounted about the shaft; and
the collar and the base being offset from each other along the shaft.

14. The flare-up preventing grill as claimed in claim 10 comprises:
a lip;
the baffle system comprises a plurality of louvers and a rotation actuator;
each of the plurality of louvers being rotatably mounted within the grill receptacle;
the rotation actuator being mechanically coupled to each of the plurality of louvers;
the lip being internally connected to the grill receptacle about the opening of the grill receptacle; and
the grill lid being perimetrically aligned with the lip.

15. The flare-up preventing grill as claimed in claim 10 comprises:
at least one grease funnel;
at least one grease pan;
the at least one grease funnel being integrated into the grill receptacle, opposite to the grill lid;
the at least one grease funnel being in fluid communication into the at least one grease pan; and
the at least one grease pan being externally mounted to the grill receptacle.

16. A flare-up preventing grill comprises:
a grill lid;
a grill body;
a water storage system;
a cooking grate;
a baffle system;
a heat source;
the grill body comprises a grill receptacle, a steam regulating outlet, and a steam overflow outlet;
the baffle system comprises a plurality of louvers and a rotation actuator;
the grill lid being perimetrically attached onto an opening of the grill receptacle;
the cooking grate being mounted within the grill receptacle, adjacent to the opening of the grill receptacle;
the baffle system being mounted within the grill receptacle, adjacent to the cooking grate and opposite to the grill lid;
the water storage system being mounted within the grill receptacle, adjacent to the baffle system and opposite to the cooking grate;
the heat source being mounted within the grill receptacle, adjacent to the water storage system and opposite to the baffle system;
the steam regulating outlet traversing out of the grill receptacle, adjacent to the grill lid;
the steam overflow outlet traversing out of the grill receptacle, adjacent to the cooking grate and opposite to the steam regulating outlet;
each of the plurality of louvers being rotatably mounted within the grill receptacle; and
the rotation actuator being mechanically coupled to each of the plurality of louvers.

17. The flare-up preventing grill as claimed in claim 16 comprises the grill receptacle being in fluid communication with a flow adjustment valve through the steam regulating outlet.

18. The flare-up preventing grill as claimed in claim 16 comprises:
a support grate;
the water storage system comprises a water reservoir, a waste bottle, a drainage valve, an inlet pipe, a one-way valve, a plurality of vents, and a deflector shield;
the inlet pipe traversing through the grill receptacle;
the inlet pipe being in fluid communication into the water reservoir through the one-way valve;
the waste bottle being positioned outside the grill receptacle;
the water reservoir being in fluid communication with the waste bottle through the drainage valve;
the plurality of vents traversing through the water reservoir, opposite to the heat source;
the deflector shield being mounted to the water reservoir, adjacent to the plurality of vents;
a lateral edge of the deflector shield being positioned offset from a lateral surface of the water reservoir;
the support grate being laterally mounted within the grill enclosure;
the support grate being positioned in-between the water reservoir and the heat source; and
the water storage system being mounted within the grill receptacle by the support grate.

19. The flare-up preventing grill as claimed in claim 16 comprises:
a lip;
the baffle system comprises a plurality of louvers and a rotation actuator;
each of the plurality of louvers being rotatably mounted within the grill receptacle;
the rotation actuator being mechanically coupled to each of the plurality of louvers;
the lip being internally connected to the grill receptacle about the opening of the grill receptacle; and
the grill lid being perimetrically aligned with the lip.

20. The flare-up preventing grill as claimed in claim 16 comprises:
a plurality of support arms;
a collar;
a shaft;
a base;
at least one grease funnel;
at least one grease pan;
the plurality of support arms being radially positioned around the collar;
the collar being internally mounted to the grill receptacle by the plurality of support arms;
the collar being laterally mounted about the shaft;
the base being laterally mounted about the shaft;
the collar and the base being offset from each other along the shaft;
the at least one grease funnel being integrated into the grill receptacle, opposite to the grill lid;
the at least one grease funnel being in fluid communication into the at least one grease pan; and
the at least one grease pan being externally mounted to the grill receptacle.
